(19) United States
(12) Patent Application Publication
(10) Pub. No.: US 2013/0033443 A1
(43) Pub. Date: Feb. 7, 2013

(54) Method of Operating an Operator Control and Monitoring Device for Safety-Critical Applications

(71) Applicants: Oliver Jöhnssen, Erlangen (DE); Andreas Zintel, Nurnberg (DE)

(72) Inventors: Oliver Jöhnssen, Erlangen (DE); Andreas Zintel, Nurnberg (DE)

(73) Assignee: Siemens Aktiengesellschaft, Muenchen (DE)

(21) Appl. No.: 13/554,446

(22) Filed: Jul. 20, 2012

(30) Foreign Application Priority Data
Aug. 1, 2011 (EP) EP11176082

(51) Int. Cl. G06F 3/041

(52) U.S. Cl. 345/173

(57) ABSTRACT

A method of operating an operator control and monitoring device for safety-critical applications in which the control and monitoring device includes a display and a touch-sensitive sensor, wherein a control element is shown on the display which an operator must touch to obtain an approval for a safety-critical application that is granted for as long as the control element is being touched, wherein first and second numbers of touch points are respectively displayed in first and second control zones, position data of the first and second control zones is selected such that the fingers of a human hand cannot simultaneously touch all touch points of the first and second control zones, and wherein the approval for the safety-critical application is only granted if all touch points from the first and second control zones are being touched.

### BACKGROUND OF THE INVENTION

1. Field of the Invention

The invention relates to a method of operating an operator control and monitoring device for safety-critical applications, where the operator control and monitoring device includes a display and a touch-sensitive sensor, and a control element is displayed on the display that an operator must touch to obtain an approval in preparation for a safety-critical application to be approved that is granted for as long as the control element is being touched.

2. Description of the Related Art

With operating machines and industrial plant using operator control and monitoring devices, operating steps for performing safety-critical applications in automation engineering, such as shutting down a press ram of a press or the sudden emergence of a stamping piston of a stamping machine, can cause injuries or physical danger for the machine operator. Such injuries can be the result of the operator's extremities potentially being located in a danger zone of the machine during operation. Such injuries can also occur if, for example, a machine operator can perform the operation with one hand and at the same time can access the danger zone of the machine with his/her second hand. This is the basis for the long-standing requirement that operating equipment of this type must not be used to operate safety-critical applications without special safety circuits.

To date, the safety of the operator has been ensured by the use of a two-handed control device, for example. Design guidelines for implementing such a two-handed control device are defined in Deutsches Institut für Normung (DIN) standard EN574. In addition, two actuators are preferably provided outside the working zone of the machine, where the two actuators must be actuated by the operator simultaneously to trigger an action by the machine. This ensures that, for example, both the operator's hands are located outside the danger zone of the machine.

### SUMMARY OF THE INVENTION

It is an object of the invention to provide a method of operating an operator control and monitoring device for safety-critical applications in which safety is further increased and additional hardware actuators outside the working zone of the machine can be eliminated.

This and other objects and advantages are achieved in accordance with the invention by a method of operating an operator control and monitoring device for safety-critical applications, where the operator control and monitoring device comprises a display and a touch-sensitive sensor, a control element is displayed on the display that an operator must touch to obtain an approval for a safety-critical application that is granted for as long as the control element is being touched. In accordance with the invention, a touch-sensitive sensor is used as a sensor, which is configured to identify multiple touches, where the control element is divided into a first control zone and a second control zone, a first number of touch points is displayed in the first control zone and a second number of touch points is displayed in the second control zone, position data of the first and second control zones is selected such that the fingers of a single human hand cannot touch all touch points of the first and second control zones. The approval for the safety-critical application is granted only if all the touch points from the first and second control zones are touched. By using a touch-sensitive sensor for operator control and monitoring devices, such as a multi-touch sensor configured to simultaneously identify multiple touch points, it is possible to ensure that the operator, for example, positions all ten fingers of both his hands on the operator control and monitoring device at positions graphically predetermined by the display of the operator control and monitoring device and thus that his hands are located outside the danger zone of the machine. To obtain approval for a safety-critical application or action, all ten fingers must, for example, be in the predetermined positions.

To further increase the approval of a safety-related application with an operator control and monitoring device, a random generator is used to determine the first and second number of touch points and thereby the number of points cannot be predicted for a renewed display of touch points.

To determine the position data of the first control and second control zones a random generator is likewise used and as a result their positions cannot be predicted for a renewed display of the control zones. By applying this method step the safety for machine operation is increased by a further degree.

A further optimization step for increasing safety is achieved in that a random generator is used to determine a first set of coordinates for the touch points in the first control zone and to determine a second set of coordinates for the touch points in the second control zone. With each renewed attempt to obtain an approval for a safety-critical operating step of the machine, the touch points are thus displayed at different positions on the display of the operator control and monitoring device. This procedure prevents the safety circuit from being circumvented by, for example, using a one-off manufactured apparatus, because the position of one or more of the individual touch points changes on the display after each action performed. Consequently, the one-off manufactured apparatus which, for example, touches the touch sensor cannot be used. Instead of using all ten fingers for the approval, the number of touch points can also vary, e.g., in a first approval step only seven touch points are required, and in a subsequent approval step nine touch points can be required at once.

In a further embodiment of the method, safety is once again increased if a further check is performed to determine whether another point on the sensor is additionally being touched and if this is the case the approval is suppressed. In other words, if a touch point other than the predetermined touch points is touched, e.g., by deliberate manipulation, the action causing the actual danger is not executed.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The drawing shows an exemplary embodiment of the inventive method on an operator control and monitoring device, in which:

FIG. 1 is a schematic diagram showing an approval being obtained by using a left human hand and a right human hand each with all five fingers in accordance with the invention;

FIG. 2 is a schematic diagram showing an attempt at a renewed approval following the approval step depicted in FIG. 1, where the left human hand and the right human hand are also used, but with a reduced number of touch points; and

FIG. 3 is a flowchart of the method in accordance with an embodiment of the invention.

### DETAILED DESCRIPTION OF THE PREFERRED EMBODIMENTS

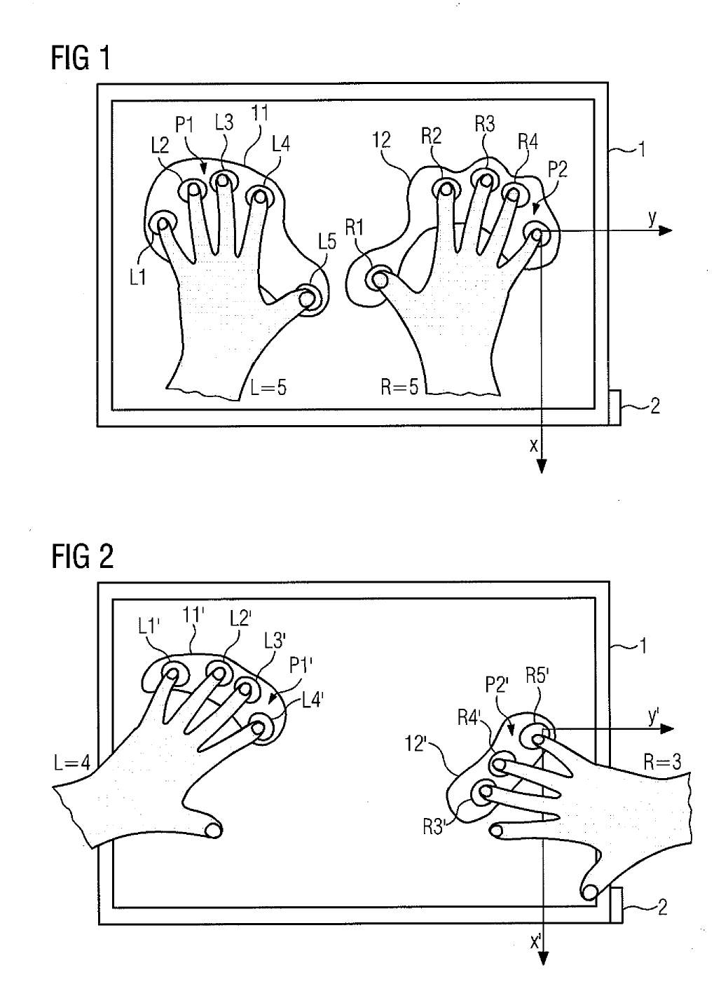

With specific reference to FIG. 1, shown therein is an operator control and monitoring device 1 with a display, such as an LCD display, and a touch-sensitive sensor, such as a resistive multi-touch sensor, disposed in front of the display.

Here, a graphics program for actuating the display and for evaluating touches of the touch-sensitive sensor is configured such that a control element for approval of a safety-critical application is divided into a first control zone 11 and a second control zone 12, where a first number L of five touch points L1, . . . , L5 is shown in the first control zone 11 and a second number R of five touch points R1, . . . , R5 is shown in the second control zone 12. Here, the position data P1 of the first control zone 11 and the position data P2 of the second control zone 12 is selected such that the fingers of the left hand cannot simultaneously touch all touch points L1, . . . , L5 of the first control zone and all touch points R1, . . . , R5 of the second control zone 12, and the approval for the safety-critical application is only granted if all touch points L1, . . . , L5 of the first control zone 11 and all touch points R1, . . . , R5 of the second control zone 12 are touched.

A random generator 2 is used to determine the first number L and the second number R of touch points. By using the random generator 2 in the method step of generating the number of touch points, the number of points cannot be predicted for a renewed display of touch points, which increases operational safety.

The random generator 2 is also used to determine the position data P1 of the first control zone 11 and the position data P2 of the second control zone 12, and as a result the positions on the graphic interface cannot be predicted for a renewed display of the control zones 11,12.

Turning now to FIG. 2, the operator control and monitoring device 1 is shown with a different display in comparison to the arrangement of the first control zone 11 and of the second control zone 12 shown in FIG. 1. The control step for approval of a safety-critical application shown with FIG. 2 chronologically follows the control step shown in FIG. 1.

To exclude any misuse, however, a different display is selected on the display for the first control zone 11 and the second control zone 12 for each renewed approval. The changed position data P1 and P2, as well as the changed touch points L1, . . . , L5 and R1, . . . , R5 and the changed coordinates X,Y, are each characterized by a apostrophe for the renewed control step in FIG. 2. Thus, position data P1′ and P2′, a new first control zone 11′ and a new second control zone 12′, new touch points L1′, . . . , L4′ and further new touch points R3′, . . . , R5′ emerge.

It is regarded as a major advantage when using the disclosed method in accordance with the invention in operator control and monitoring devices that it is possible to use standard operator control and monitoring devices without additional separate safety circuits or safety switches for safety-critical actions. The method in accordance with the invention can be implemented in currently existing operator control and monitoring devices. It is merely necessary to ensure that the touch-sensitive sensor is already present as a sensor for a multi-touch panel.

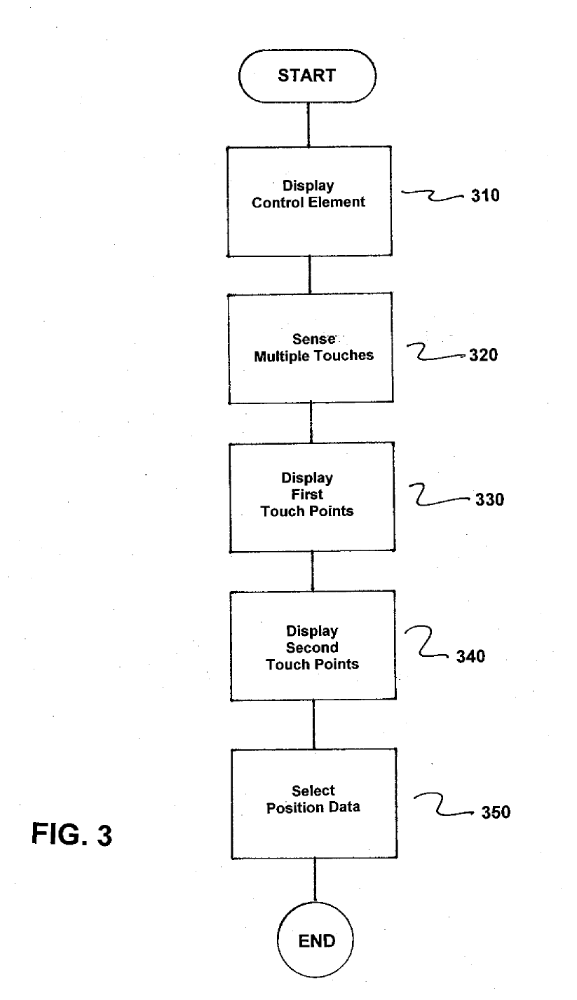

FIG. 3 is a flowchart of a method of operating an operator control and monitoring device for safety-critical applications, where the operator control and monitoring device include a display and a touch-sensitive sensor configured to identify multiple touches. The method comprises displaying a control element on the display for touch by an operator to obtain an approval for a safety-critical application granted for as long as the control element is touched, as indicated in step 310.

Multiple touches are sensed with the touch-sensitive sensor configured to identify the multiple touches, as indicated in step 320. Here, the control element is divided into a first control zone and a second control zone.

A first number of touch points is then displayed in the first control zone, as indicated in step 330. A second number of touch points is next displayed in the second control zone, as indicated in step 340. Position data of the first and second control zones is now selected such that fingers of a hand cannot simultaneously touch all touch points of the first number of touch points of the first control zone and all touch points of the second number of touch points of the second control zone, as indicated in step 350. In accordance with the method of the invention, the approval for the safety-critical application is only granted if all the touch points of the first control zone and all the touch points of the second control zone are simultaneously touched.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those method steps which perform substantially the same function in substantially the same way to achieve the same results are within the scope of the invention. Moreover, it should be recognized that method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method of operating an operator control and monitoring device for safety-critical applications, the operator control and monitoring device comprising a display and a touch-sensitive sensor configured to identify multiple touches, the method comprising:
displaying a control element on the display for touch by an operator to obtain an approval for a safety-critical application granted for as long as the control element is touched;
sensing multiple touches with the touch-sensitive sensor configured to identify the multiple touches, the control element being divided into a first control zone and a second control zone;
displaying a first number of touch points in the first control zone;
displaying a second number of touch points in the second control zone; and
selecting position data of the first and second control zones such that fingers of a hand cannot simultaneously touch all touch points of the first number of touch points of the first control zone and all touch points of the second number of touch points of the second control zone;
wherein the approval for the safety-critical application is only granted if all the touch points of the first control zone and all the touch points of the second control zone are simultaneously touched.

2. The method as claimed in claim 1, further comprising:
determining, by a random generator, the first number of the touch points and the second number of the touch points such that the number of touch points cannot be predicted for a renewed display of the touch points.

3. The method as claimed in claim 1, further comprising:
determining, by a random generator, the position data of the first control zone and the second control zone such that the positions of the first and second control zones cannot be predicted for a renewed display of the first and second control zones.

4. The method as claimed in claim 2, further comprising:
determining, by the random generator, the position data of the first control zone and the second control zone such that the positions of the first and second control zones cannot be predicted for a renewed display of the first and second control zones.

5. The method as claimed in claim 1, further comprising:
determining, by a random generator, a first set of coordinates of the first number of touch points in the first control zone; and
determining, by the random generator, a second set of coordinates of the first number of the touch points in the second control zone.

6. The method as claimed in claim 2, further comprising:
determining, by the random generator, a first set of coordinates of the first number of touch points in the first control zone; and
determining, by the random generator, a second set of coordinates of the second number of touch points in the second control zone.

7. The method as claimed in claim 3, further comprising:
determining, by the random generator, a first set of coordinates of the first number of touch points in the first control zone; and
determining, by the random generator, a second set of coordinates of the second number of touch points in the second control zone.

8. The method as claimed in claim 1, further comprising:
checking to determine whether another touch point is being additionally touched on the sensor; and
suppressing the approval if another touch point is being additionally touched on the sensor.
